(19) United States
(12) Patent Application Publication
(10) Pub. No.: US 2026/0089623 A1
(43) Pub. Date: Mar. 26, 2026

(54) METHOD FOR RECEIVING WIFI SIGNALS

(71) Applicant: SIRIUS WIRELESS PTE. LTD., Singapore (SG)

(72) Inventors: Chun-Pang WU, Taipei City (TW); Yi-Chin TSOU, Taipei City (TW); Pang-Ning CHEN, Taipei City (TW); Benjamin CHIANG, Taipei City (TW); Pei-Si WU, Taipei City (TW)

(73) Assignee: SIRIUS WIRELESS PTE. LTD., Singapore (SG)

(21) Appl. No.: 19/334,170

(22) Filed: Sep. 19, 2025

(30) Foreign Application Priority Data
Sep. 20, 2024 (TW) 113135765

(51) Int. Cl. H04W 52/02; H04W 84/12

(52) U.S. Cl. CPC H04W 52/0206; H04W 84/12

(57) ABSTRACT

The present invention provides a method for receiving WIFI signals. The method includes using a wireless local area network path to transmit digital signals generated by a digital user device to an access point of a receiver. These signals include those from the bandwidth of certain user devices; and filters to change the position of the center frequencies of these user devices so that these signals combine the I and Q path ΔΣADC into a single composite ΔΣADC at a smaller sub-channel bandwidth, and select proper location of this center frequency and reduce its clock rate.

### TECHNICAL FIELD The present invention relates to a method for receiving WIFI signals applied to IoT for the purpose of power saving.

### BACKGROUND

Wi-Fi is a wireless local area network (WLAN) technology based on the IEEE 802.11 standard, and has been widely applied to notebook computers, tablet computers, smartphones, and various electronic products. A WLAN usually includes an access point and multiple stations, with the access point maintaining a connection with each station. If each station can transmit data to the access point at any time, then the power consumption of the device will increase significantly. Wi-Fi 6 (also known as IEEE 802.11ax) adopts Target Wake Time (TWT) technology, allowing the access point to define a TWT service period (SP) for a group of stations or an individual station. Within this service period, the station can carry out data transmission with the access point.

IEEE 802.11ax has multiple functions for reducing power consumption requirements. The target wake time allows user-end devices to sleep for extended periods while setting the wake-up and communication times with the access point. In particular, the Orthogonal Frequency Division Multiple Access (OFDMA) technology is included, whose main method of operation is to aggregate multiple smaller packets into larger packets and then transmit them at once, thereby reducing bandwidth burden and improving data transmission efficiency. The OFDMA in 802.11ax enables Wi-Fi to reduce such differences within system-level scope, thus expanding its applicability in the IoT ecosystem. Meanwhile, wiring of sensor locations is often impossible or inconvenient, so many IoT devices are battery-powered, making power consumption a critical consideration. OFDMA provides several functions for reducing power consumption, with target wake time allowing client devices to remain in sleep mode for long periods and only wake up to communicate with the access point at scheduled times. This is particularly useful when IoT devices rarely need to transmit and receive long frames, and still meet the requirement of infrequent yet reliable communications. Over the years, several specialized chip suppliers have introduced improved 802.11 chips for IoT applications (e.g., WiFi asset tags) to maximize power saving in many ways. However, the market capacity of such specialty chips is very limited, and their designs are restricted by the need to interoperate with other WiFi devices (including access points).

Therefore, there is presently a need for a method for receiving WIFI signals that achieves power saving, particularly in WIFI devices with OFDMA functionality. In view of this, the inventor has invested significant research and development effort, constantly making breakthroughs and innovations in this field, aiming to solve the deficiencies of conventional methods with novel technical means, provide better products for society, and further promote industrial development.

### SUMMARY OF THE INVENTION

The primary objective of the present invention is to provide a method for receiving WIFI signals in order to overcome the defects and deficiencies of existing technology. In this invention, the resistance value in a circuit may be altered or the voltage value adjusted to shift the position of the center frequency to a suitable location, achieving power saving in the signal reception method. Furthermore, for IoT devices, a mode supporting only 20 MHz channels is introduced, allowing simpler and less powerful chips to operate in this mode only. Several new options in the specifications are designed to promote new product lines of small-sized, function-limited chips for the IoT market to achieve the lowest power consumption required for IoT performance ranges.

To achieve the above objective, the present invention provides a method for receiving WIFI signals, including: using a wireless local area network to transmit signals generated by multiple user devices to an access point of a receiver, wherein the signals include bandwidths from the user devices; and employing a filter to change the position of the center frequencies of the user devices such that, under a smaller sub-channel bandwidth, the I and Q path ΔΣADCs are combined into a single composite ΔΣADC, and the suitable center frequency position is selected with reduced clock rate.

The method for receiving WIFI signals as disclosed in the present invention enables the creation of new product lines of small-sized, function-limited chips for the IoT market so as to achieve the lowest power consumption required within the IoT performance range.

### BRIEF DESCRIPTION OF THE DRAWINGS

FIG. 1 is a schematic diagram of an embodiment 1 of the method for receiving WIFI signals according to the present invention.

FIG. 2 is a schematic diagram of an embodiment 2 of the method for receiving WIFI signals according to the present invention.

### DETAILED DESCRIPTION OF THE INVENTION

The following describes the embodiments of the present invention in detail. Those skilled in the art can easily understand other advantages and effects of the invention from the disclosure of this specification. In addition, the invention can also be implemented or applied by other different specific embodiments and various modifications and changes can be made without departing from its spirit.

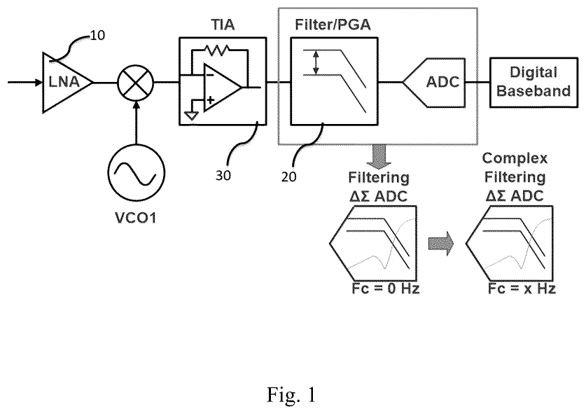

As shown in FIG. 1, the method for receiving WIFI signals of the present invention includes: using a wireless local area network 10 to transmit signals generated by multiple user devices to an access point of a receiver, wherein the signals include bandwidths from the user devices; and employing a filter 20 to change the position of the center frequencies of the user devices such that, under a smaller sub-channel bandwidth, the I and Q path ΔΣADCs are combined into a single composite ΔΣADC, and the suitable center frequency position is selected with reduced clock rate. A transimpedance amplifier 30 is utilized to adjust resistance values in the circuits of the user devices in order to shift the center frequency positions. This embodiment is especially applicable to WIFI systems with OFDMA functionality.

W0/s is the internal building block of continuous-time ΔΣADC; without cross-coupled blocks WC/W0, the I and Q paths will respectively realize H(s)=W0/s; with the cross-coupled block, a first-order transfer function with a single pole can be found at s=jWC, and therefore the resulting filter will be a positive frequency resonator where H(s)=W0/(s−jWC). In a real case of a second-order composite ΔΣADC, it is found to be composed of two resonators.

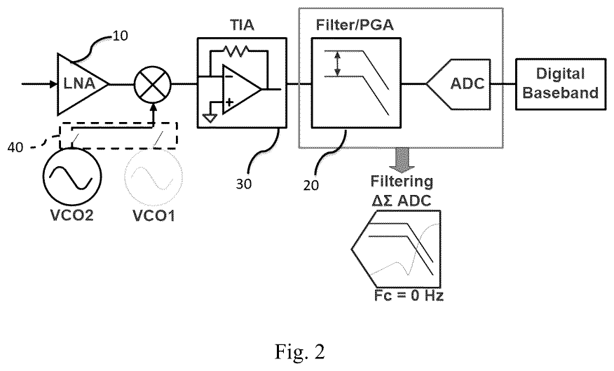

As shown in FIG. 2, the method for receiving WIFI signals of the present invention includes: using a wireless local area network 10 to transmit signals generated by multiple user devices to an access point of a receiver, wherein the signals include bandwidths from the user devices; and employing a filter 20 to change the positions of the center frequencies of the user devices such that, under a smaller sub-channel bandwidth, the I and Q path ΔΣADCs are combined into a single composite ΔΣADC, and the suitable center frequency position is selected with reduced clock rate. A switch 40 is utilized to adjust the voltage values in the circuits of the user devices in order to shift the center frequency positions. The access point supports complete 20 MHz channels in the 2.4 GHz band, as well as 20, 40, and 80 MHz channels in the 5 GHz or 6 GHz bands.

The method for receiving WIFI signals of the present invention selects proper center frequency positions and reduces clock rate under smaller sub-channel bandwidths to achieve the same DR on designated sub-channels. A smaller sub-channel bandwidth means that the ADC sampling rate can be reduced while maintaining the same oversampling ratio and sufficient noise-shaping capability. In addition, once a smaller bandwidth is arranged, the current consumption of the transimpedance amplifier (TIA) can be reduced.

The above descriptions are merely preferred embodiments of the present invention and are not intended to limit the scope of patent protection. Any equivalent changes made based on the disclosure of the specification and drawings shall be included within the scope of protection of the present invention.

### DESCRIPTION OF SYMBOLS

10 Wireless Local Area Network
20 Filter
30 Transimpedance Amplifier
40 Switch

1: A method for receiving WIFI signals, comprising:
using a wireless local area network to transmit signals generated by multiple user devices to an access point of a receiver, wherein the signals include bandwidths from the user devices; and
employing a filter to change the positions of the center frequencies of the user devices such that, under a smaller sub-channel bandwidth, the I and Q path ΔΣADCs are combined into a single composite ΔΣADC, and the suitable center frequency position is selected with reduced clock rate.

2: The receiving method according to claim 1, wherein a transimpedance amplifier is utilized to adjust resistance values in the circuits of the user devices in order to shift the center frequency positions.

3: The receiving method according to claim 1, wherein a switch is utilized to adjust voltage values in the circuits of the user devices in order to shift the center frequency positions.

4: The receiving method according to claim 1, wherein the access point supports complete 20 MHz channels in the 2.4 GHz band, as well as 20, 40, and 80 MHz channels in the 5 GHz or 6 GHz bands.
